(19) United States
(12) Patent Application Publication
(10) Pub. No.: US 2011/0260908 A1
(43) Pub. Date: Oct. 27, 2011

(54) METHOD FOR MITIGATING THE EFFECTS OF CLUTTER AND INTERFERENCE ON A RADAR SYSTEM

(75) Inventors: Christopher New, Portsmouth (GB); Alan Peter Lavell-Smith, Portsmouth (GB)

(73) Assignee: QINETIQ LIMITED, Farnborough, Hampshire (GB)

(21) Appl. No.: 13/133,549

(22) PCT Filed: Dec. 8, 2009
(86) PCT No.: PCT/GB2009/002837

§ 371 Date: Jun. 8, 2011

(30) Foreign Application Priority Data
Dec. 10, 2008 (GB) 0822468.5
Apr. 21, 2009 (GB) 0906826.3

(51) Int. Cl. G01S 13/87

(52) U.S. Cl. 342/59

(57) ABSTRACT

A method for mitigating against a clutter source or other interferer in a high precision radar is disclosed. The clutter source or interferer may be a wind farm. The method includes positioning a plurality of relatively low resolution radars, such as low cost marine navigation radars, in or about the interferer, and fusing data from them together, to produce object positional data of increased accuracy. One or more of the radars may be adapted to have a radiation beam pattern directed more towards the vertical, and such adapted radars may advantageously be located more centrally within the interfering region. Data from the individual radars may be fused in any suitable manner, and other information, such as ADS-B broadcasts may be included. Data relating to aircraft may be supplied to operators to supplement air traffic control, and air defence radars, and data relating to shipping around sea based wind farms supplied to vessel traffic system radar operators.

The present invention relates to methods and systems for operating radar systems. More particularly, it relates to methods for ameliorating the performance of a high precision radar in regions of significant interference and/or clutter such as that caused by wind farms, or in regions poor coverage, and to systems adapted to carry out the methods.

The aviation industry relies on a network of air traffic control (ATC) radars distributed throughout the world to provide location data of aircraft in flight. These are primary radar systems, which provide a non-cooperative method of detecting each aircraft, which is important as many small or light aircraft do not carry secondary surveillance radar (SSR) transponders. Hence, they would not be detectable in any other way at the ranges required in the ATC environment. There are different types of ATC radar, the principle ones being en-route and approach radars. The positional accuracy of the data they generate is clearly very important as it is used by air traffic controllers (ATCOs) to manage the air traffic safely, through the separation of aircraft in range, bearing and altitude (height). In particular, the approach radars, which control aircraft entering or leaving an airport, are very important to ensure that there are no conflicts with the large number of aircraft in the vicinity of airports, particularly where both large and small/light aircraft use the same airport. There also exists a network of air defence (AD) radars in the UK that is primarily used by the Ministry of Defence (MoD) for command and control purposes relating to military aircraft and potential airspace infringements, and likewise the detection and accuracy of these radars is very important for similar reasons. Similarly, the Royal Air Force (RAF) and the MoD have a network of ATC radars to help control and direct military aircraft in around areas of the UK, including military ranges, military airports and through certain areas of UK airspace. These MoD ATC radars have similar characteristics to civilian ATC radars and can suffer the same issues and concerns for interference and clutter from wind farms, etc. In addition to these, there are a series of networked marine navigation radars sited along the coastal regions of the UK, known as the vessel traffic system (VTS) radars, which exists to organise traffic or provide traffic information and navigational assistance services to maritime vessels. Each network of VTS radars provides the navigational assistance for a particular port authority around the UK. For each of these roles it is highly preferable that the radar presents as accurate and uncluttered/interference free picture to the radar operator as possible.

Recent concern with climate change has created a proliferation in renewable electricity generation. One of the main means of generating energy in this manner is the use of wind powered turbines. Wind turbines typically consist of a nacelle, housing the electricity generating components, and a blade assembly, which are supported by a metallic tower, typically of cylindrical construction. Wind turbines can be extremely large, with blades of up to 45 metres or more in length, mounted on towers that can be up to around 100 metres tall. They thus tend to have a large radar cross section (RCS), and can cause problems like saturation of the radar receivers due to the high strength reflection, and radar shadowing. The movement of the blades also adds a Doppler velocity shift to reflected signals. The Doppler characteristics are complex, due to the different parts of a blade travelling at different speeds and having different RCS characteristics. However, with the turbine blades being a moving item and having both a large RCS and a Doppler velocity, the blades can be readily detected by radars using movement detection techniques such as moving target indication (MTI) and Doppler/moving target detection (MTD). Unlike ATC or AD radars, VTS radars generally have no velocity clutter cancellation systems, such as MTI, to help remove the interference/clutter generated turbine reflections (both from the tower and from the blades).

Wind turbines for power generation are typically located on land in rural areas and comprise one or more wind turbines. They are popularly known as wind farms. A typical wind farm may have 20 to 40 individual wind turbines, whereas larger wind farms may have around 100 turbines. More recently, wind farms are being developed off the coast of the UK, with these offshore wind farms consisting of several hundred turbines. The towers may be distributed over an area of many tens of square kilometres. The RCS of a wind farm may, therefore, be very large. Typically, demand for the best locations for wind farms where the mean wind speeds are high, can lead to them being located under the direct flight paths for aircraft, within close proximity to an airport or in/close to major shipping lanes, which can present ATC, AD or marine navigation radars with significant interference or clutter returns. In particular, the combination of turbine RCS and Doppler signals generated by the rotating blades can cause significant interference, and such interference is very similar in terms of radar aspects to those expected from real world objects, such as aircraft, helicopters etc, that the radars are trying to detect. Other potential problems include radar receiver saturation, radar shadowing and target modulation effects. The interference primarily occurs over the region of the wind farm, but due to some types of radar processing, the problem can extend over a greater region than just that of the immediate wind farm. In the UK this has led to objections from both military and other sources at the planning stage of a new wind farm, even if the wind farm comprises of just a few or even a single turbine. The same problems, in terms of radar signal issues and planning issues occur if the wind farm is located at sea, with radar receiver saturation and radar shadowing being more prominent. The report “Results of the electromagnetic investigations and assessments of marine radar, communications and positioning systems undertaken at the North Hoyle wind farm by QinetiQ and the Maritime and Coastguard Agency”, Howard, M, Brown C, Qinetiq/03/00297/1.1, MCA MNA 53/10/366 detailing research undertaken by the Maritime Coastguard Agency (MCA) has indicated that offshore wind farm structures have the potential to interfere with marine systems such as shipborne and shore based radar. Offshore wind farms cover large areas of open water and present hazards to navigation.

One solution to this problem for the aircraft community is to site further ATC or AD radars in locations from which the wind farm is not visible. For example, a second ATC or AD radar located with a hill or similar terrain type obstruction between it and the wind farm prevents radar pulses from illuminating the wind farm, and thus no returns from the wind farm will be received. The expense of these high precision radars makes this solution impractical from a cost point of view, and some wind farm locations may not be located near convenient terrain obstructions. Additionally, this terrain blockage technique tends to work only for one radar/wind farm combination and hence if two wind farms are causing an issue another “patch-in” or “fill-in” radar is required, along with its associated costs, infrastructure requirements, etc. It can be difficult to find one patch-in radar location that has appropriate terrain obscuration that could be used for more than one affected ATC or AD radar, even if the same wind farm is affecting two or more ATC radars. Similar problems exist for the maritime community, with radar shadowing and target confusion being overcome by having an additional VTS radar mounted the other side of the wind farm, if possible.

Other solutions are being developed to help mitigate the problems. One example is the use of radar absorbent materials (RAM) on or in the blades and turbines that provide a reduced reflectivity to radar signals. These materials are not yet efficient enough to absorb all the radar energy, and thus some energy will still be reflected back to the radar. Other solutions lie in alterations to the ATC or AD radars themselves, with either hardware or software upgrades, but such techniques are relatively immature and have not performed well to date. Typical examples of these alterations include modifications to the plot extractor or track extractor to prevent new plots/tracks from within the area of the wind farm. Such techniques do not prevent the radar from detecting interference from the wind farms, but typically instead provide processing algorithms that stop the interference from being presented to the radar operator. Another solution, being developed by Cambridge Consultants, involves the development of a holographic radar system. This system allows limited three dimensional (3D) high resolution (range/angular accuracy) “imaging” of objects using multiple non-rotating phased array bistatic radar antennas and complex signal processing techniques, that can distinguish between objects like wind turbines and aircraft. Development of this system is, however, still in its infancy.

According to a first aspect of the present invention there is provided a method for mitigating the effects of an interferer or region of poor propagation on a high precision radar system comprising the steps of:
a) siting at least two lower accuracy radars, each having relatively lower accuracy compared to the high precision radar, at different positions in the vicinity of the interferer or region, with each being arranged to view a common area above or around the interferer or region;
b) recording radar data, using the at least two lower accuracy radars, from objects moving within the common area;
c) fusing together the data from the at least two lower accuracy radars to generate object location data having improved accuracy;
d) sending the improved accuracy object location data to an operator of the high precision radar for integration with existing data from the high precision radar.

The use of a plurality of relatively lower accuracy radars as described herein gives a significant cost saving compared to installing and commissioning a second ATC, AD or VTS radar. Furthermore, the present method can be deployed in areas such as large flat regions, or open sea, where no suitable barrier is available to shield the ATC, AD or VTS marine navigation radar behind. The method also allows convenient application to two or more ATC, AD or VTS marine navigation radars affected by the same wind farm, as the data provided by the method can be transmitted as desired to multiple radar operators.

Note that the term “lower accuracy radar” as used herein refers to the accuracy of the individual radar in terms of one or more of the range, azimuth or Doppler resolution as compared to that of normal ATC, AD or VTS radars. A “lower accuracy radar” may still have an accuracy acceptable for, e.g. basic marine navigation or other similar tasks where the high accuracies needed for the control of aircraft or precision monitoring of shipping are not required. An individual lower accuracy radar may also have a lower output power and a smaller antenna than the standard ATC, AD or VTS radars.

Beneficially, the plurality of lower accuracy radars may provide an improvement in detection capability, an increase in tracking capability, and an increased update rate of a target track for targets in the common area as compared to that of a typical ATC or AD radar. Typically an ATC or AD radar will scan, and hence provide track updates, every four to ten seconds or so. Cheaper navigational radars of the type employed in the current invention typically perform a full 360° scan in azimuth in a time period between one and a half seconds to two and a half seconds. This means that typically each lower accuracy radar may view the target at least twice as often as the ATC or AD radar, and may allow up to around six times as many target views per ATC or AD radar rotation. The use of such radars in the present invention allows more rapid updates to targets in the common area due to this increased scan rate. Preferably at least three lower accuracy radars will be used, although a minimum of two radars will still be able to provide 3D plot information albeit possibly over a more limited area of surveillance. The benefit of a larger number of lower accuracy radars, however, is that accuracy can be improved, and the data update rate will be quicker. Larger sites may benefit from more than three, such as five or even seven radars distributed as described herein.

The use of a plurality of lower accuracy radars, suitably positioned about the region to be monitored, provides multiple look angles when scanning the region. By using multiple look angles the radar configuration is able to provide a significant improvement in the azimuth and range accuracy of a detected target track. The ability to have multiple look angles also means that the two dimensional (2D) (slant range and bearing) data provided by each of such radars may be combined to provide 3D track (range, height and bearing) information where at least two of the plurality of lower accuracy radars views the same target, although it will be appreciated that the use of more radars, suitably spaced, will generally lead to improved accuracy. Additionally, the use of more radars will reduce the effects of blockage and interference from the affected region to the overall system through the increased fields of view to the target and significantly higher number of track/plot updates.

The common area may be, for land based wind farms (or other interferers) the region above, and around the wind farm, within the range of the lower accuracy radars that is within range of most or all of the radars. For sea based wind farms the common area may be the sea surface surrounding the wind farm, the air above and around it or both, depending upon which operators are to receive the fused data.

The lower accuracy radars may conveniently be relatively cheap navigation radars. Models such as the Sperry Bridgemaster E series, GEM Elletronica Leonardo series or the Kelvin Hughes Nucleus series may be suitable. They may be based on existing cheap magnetron technology but given the rise of increasingly reduced cost of solid state radars these may be used instead. The lower accuracy radars may be based upon relatively cheap navigation radars using simple pulsed radar, a medium pulse rate Doppler-type solid state radar or even frequency modulated radar technologies or a combination of these. They may have a rotatable antenna having a narrow beam in one axis, typically the azimuth axis) and a wide beam in a second, orthogonal axis. These radars are designed to be employed in the marine environment. Therefore it is preferable that the antennas of one, some, or all of these lower accuracy radars (and other marine radars as appropriate) may be adapted as described herein to direct more energy skyward than is normally the case. The amount of adaptation, and the number of adapted antennas required is dependent, inter alia, upon the placement of these antennas and the environment in which they are being used. A larger wind farm for example may have more lower accuracy radars modified to direct more energy skywards. The plurality of radars may advantageously each be located spatially separately from the others, in locations about or within the region of the interferer or in a peripheral region surrounding the interferer. In some cases, the lower accuracy radars may be mounted on top of or on the sides of the peripheral interferers (i.e wind-turbines in a wind farm). This has the benefit that improved positional accuracy may be obtained once data from each is combined, or fused together.

Advantageously the radars may be divided into a first and a second group, with one or more radars in each group, wherein the characteristics of the antennas of the radars in the first group differs from the characteristics of the antenna in the second group. The first group may have antennas that direct their energy more skyward than those of the second group. That is, the beam patterns of the radars in the first group may be directed to a higher elevation angle than those of the second group. Radars of the first group therefore are able to provide improved coverage of targets flying directly above the radar itself. The radar may be arranged to detect targets up to standard commercial air lane heights, i.e. 50 kft or more. Radars from the first group may also have a reduction in any interference they receive back from the wind farm, as they will tend to direct less energy at the wind farm's turbines. This interference reduction may be further improved by using radar clutter fences to reduce the backscatter from the wind farm and surrounding terrain.

Advantageously at least one lower accuracy radar, which may comprise a radar of the first group, is located in a central area of the wind farm or other interferer, or in an inner peripheral area, e.g. adjacent an edge of the interferer. A single radar having an antenna as described can provide, when mounted to have a vertical axis of rotation, slant range and azimuth information. This gives uncertainty as to target height, with the height being anywhere within the beam of the antenna on the circumference of a circle segment, the circle having the slant range as a radius. By incorporating at least two such radars having separate locations but sharing a view of the region above the interferer, the target can be localised according to the crossing point of the circumference plotted from each radar. Adding further radars in different locations improves accuracy still further.

Preferably at least two of the lower accuracy radars will have different frequencies of operation. The benefit(s) of a larger number of lower accuracy radars operating over different radio frequencies of operation include
1. each radar will have a unique view of the target in terms of its characteristics and the radio frequency (RF) propagation conditions between it and the target.
2. More updates provide improved track accuracy, track maintenance, etc
3. Multiple frequencies (particularly frequency bands), ensures that multipath from each radar to the target is at a different location, so that the overall track suffers significantly less blind zones
4. There is a reduction in the interference between sets of radars
5. The impact of rain and other atmospheric clutter has a different impact on each radar as they are typically frequency dependent.

Some or all of the lower accuracy radars may be chosen to operate in different frequency bands from each other. For example, one or more radars may be operative in X-band, and one or more others may be operative in S band. Other bands, such as C-band or Ku-band may also be chosen, depending upon factors such as mutual interference, interference with other systems, or upon convention given the particular environment in which it is to be used.

It should be noted that, in general, the frequencies of operation of the lower accuracy radars operative in a particular frequency band and typically used in the present invention tend to all operate at the same or similar centre frequency, particularly if they use magnetrons as their source. It may therefore be advantageous to choose radars operative in different frequency bands, to gain the advantages discussed above.

Some or all of the lower accuracy radars may also be arranged to use different transmit pulse widths from each other. This may help to reduce mutual interference between radars sited in close proximity. In addition, it will also allow the radars to have different maximum detection ranges for the same target RCS and to allow variations in the target resolution capabilities of each.

The antenna of each lower accuracy radar may be arranged to scan the region above the interferer, and to record location data of returns from targets. The antenna may be arranged to have a beam pattern having a narrow azimuth beam and a wide elevation beam. The antenna may advantageously be arranged to produce a beam skewed to direct most of its energy skyward as described herein. The skew of the beam for a given location may be chosen dependent upon the particular terrain characteristics and on the interferer geometry. Such a skew, or tilt, of the antenna beam will tend to reduce antenna coupling to the ground, reducing land or sea clutter returns, enhancing air target detection and reducing interference returns from the interferer. The skew also provides better tracking coverage directly above interferer.

Certain types of commercial off the shelf (COTS) lower accuracy radars are capable of being modified to improve their accuracy by employing known techniques on their outputs. For example, increasing a digitisation rate of data from the radar may provide an increased range resolution. Also, within-beam integration of radar returns may provide improved azimuth accuracy. Such techniques may be carried out on the lower accuracy radars to improve their inherent performance at relatively low cost. Fusion of the outputs of such radars will have similarly improved accuracy.

Each of the at least two lower accuracy radars may be connected to a computer or processing system, used to process data from the individual radar, as described below. These computers may be known as radar processing units (RPUs). The radars may provide a video signal to the RPUs in analogue or digital form The data from the lower accuracy radars may be pre-processed in the RPUs to reduce false alarms and/or to help remove high levels of interference or clutter and, thus, improve probability of detection. The pre-processing may include known radar processing techniques such as sensitivity time control (STC) and fast time constant (FTC) processing to reduce clutter effects, and may further include within-beam integration to improve resolution in azimuth. This pre-processing may also include both long term and short term clutter map storage.

The pre-processing may generate plot information of targets. The plot information may comprise at least bearing and slant range information. The RPUs may provide information to a centralised computer adapted to perform a sensor fusion function, known as a sensor plot fusion engine (SPFE), that combines data from the individual radars to produce more accurate positional data for each target seen by the radars.

Plot fusion is a method of combining individual sensor measurements into a common track state estimate. In contrast, track fusion forms a state estimate from the combination of multiple tracks from each sensor. Plot fusion has the advantage of improving continuity, completeness and timeliness of output tracks. Common causes of track loss such as intermittent fades, jamming, manoeuvres, multipath and obscuration are mitigated when the sensors are in different positions, heights, operating frequency and/or are dissimilar in other ways. The plot fusion process may receive plot information from the pre-processors (RPUs) of a plurality of radars and combine this information to produce track information of improved accuracy. The fused information may comprise 3D tracks, i.e. track information that contains target altitude information in addition to bearing and range information. The fusion process may use known data fusion techniques, such as Kalman filter or Extended Kalman filter (EKF) fusion techniques. See for example “Improved Kalman Filter Design for Three-Dimensional Radar Tracking” Seong-Taek Park & Jang Gyu Lee, IEEE TRANSACTIONS ON AEROSPACE AND ELECTRONIC SYSTEMS VOL. 37, NO. 2 APR. 2001 pp 727-739. See also Blackman, S. S., and R. Popoli, “Design and Analysis of Modern Tracking Systems”, Artech House, 1999.

An embodiment of the present invention may use an SPFE for the sensor fusion function, which may be based upon a multiple hypothesis tracker (MHT) EKF. The SPFE may use a centralised tracker processing data from a plurality of radars with lower accuracy. The SPFE takes all the plots (targets, clutter, noise, etc.) from each contributing sensor/radar, where they are combined and then used for track initiation, track maintenance and track deletion. By using all the plots from each contributing sensor, the SPFE may initiate a target track quicker than a single radar, provide better track maintenance and also hold a track longer. Depending upon the environment and the requirements from the system, the SPFE unit may consist of a single SPFE using MHT EKF covering all velocities of expectation. In more demanding environments, the SPFE unit may consist of a number SPFEs using MHT EKF but each with a limited set of hypothesis to allow both a classification of potential environment for the target and to enhance detection.

To help with controlling the fact that the plurality of lower accuracy radars will provide plots containing both valid targets and clutter, the SPFE may include advanced clutter reduction and interference techniques similar to that utilised in the RPU, particularly the long and short term clutter maps. Advantageously, the SPFE can provide a global ‘shared’ clutter map with each RPU to further improve clutter rejection in the RPU. This may be more important in areas where the plurality of radars is widely spread and there is significant clutter around the interference region. Thus in this manner clutter may be processed at the level of both the individual radar and at system level.

The SPFE may be adapted to incorporate data from non radar based sensors, such as the Automatic Dependent Surveillance Broadcast (ADS-B) or Automatic Identification System (AIS). These are typically receiver units that capture automated position and identification reporting messages from certain target types, particularly commercial aircraft and shipping. The SPFE may be arranged to strip out useful position information from these broadcasts and fuse it with the information from the radars. Identification information as well as positional information may be used.

In, areas where there are very high levels of interference or clutter, then the SPFE may use a distributed tracker model. This will enable each radar sensor to have its number of output plots to a central tracker to be controlled to prevent overloading of the central tracker. This may be done by only releasing plots to the central tracker associated with tracks already held by the distributed trackers at each lower accuracy radar or releasing only those plots over a specific confidence threshold.

The processed data, comprising data from individual radars fused to produce improved accuracy information relating to targets in the common area may be passed to subscribing ATC or AD radar operators via a user adaption interface (UAI). The purpose of the UAI is to take the available plot, track, etc information and provide it in the requisite format for the end user. The data may be sent in any convenient format. A transmission control protocol/Internet protocol (TCP/IP) may be used. The data format may be matched to that used by each subscribing operator. The data format may be the All Purpose Structured Eurocontrol Surveillance Information Exchange (ASTERIX) 21 format, which is one of the most common data exchange formats in the ATC community.

According to a second aspect of the present invention there is provided a system for mitigating the effects of an interferer or region of poor propagation on a high precision radar, the system comprising:
a) a first group comprising at least one lower accuracy radar, and
b) a second group comprising at least one lower accuracy radar, wherein each radar in each group has a relatively lower accuracy as compared to the high precision radar, and
c) a computer system adapted to receive data from the radars in the first and second groups, the data comprising bearing and slant range information of detected targets, and to fuse the data to produce data having improved positional accuracy of the detected targets,
characterised in that the at least one radar in the first group is adapted to have an antenna having a radiation pattern sensitive at an increased elevation angle as compared to the at least one radar in the second group.

The radar or radars in the first group may advantageously be located in a central area of the interferer or region of poor propagation, or in an inner peripheral area about the central area, whereas those of the second group may advantageously be located more peripherally around those in the first group.

The computer system may be adapted to fuse the data from the lower accuracy radars using a filtering operation to generate target position information in three dimensions. The computer system may comprise a processor having a connection to computer memory and be capable of receiving data at an input port, performing operations on received data governed by a program stored in memory, and presenting processed data to an output port.

The invention will now be described in more detail, by way of example only, with reference to the following Figures, of which:

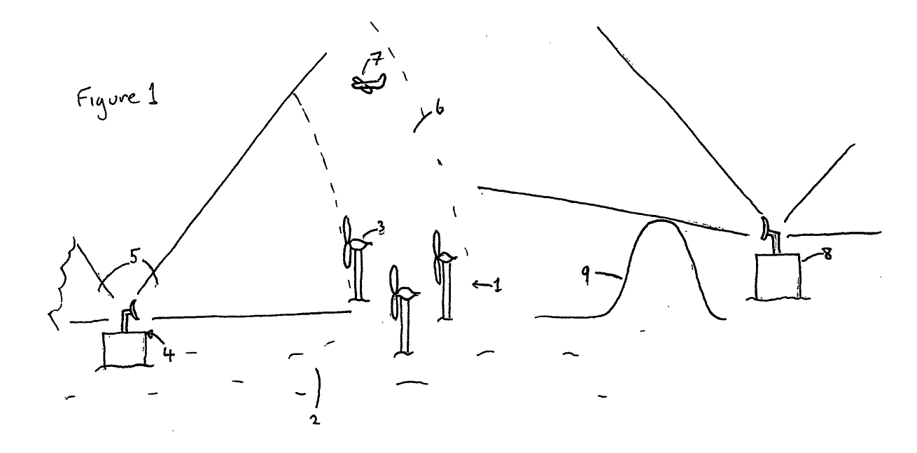

FIG. 1 diagrammatically illustrates a typical scenario showing an ATC radar and a wind farm, with a region of interference above the wind farm;

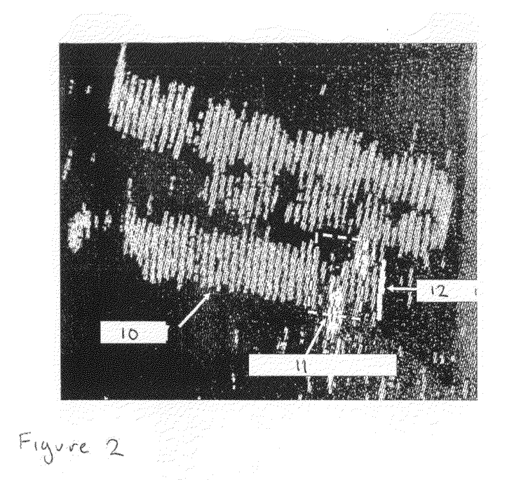

FIG. 2 shows the impact of wind farm turbine interference on the display of an ATC radar;

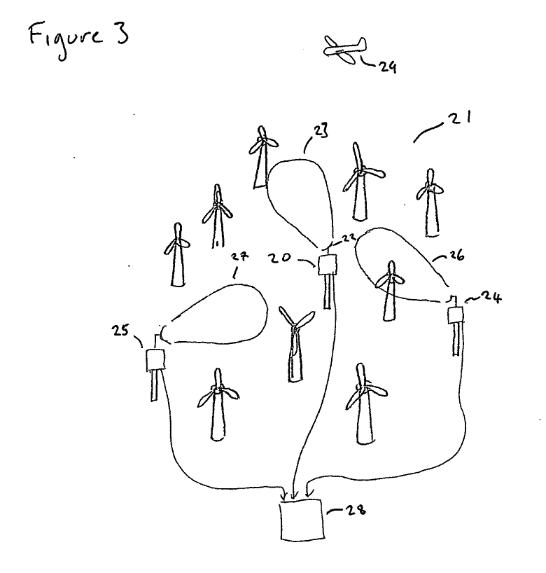

FIG. 3 diagrammatically illustrates a typical scenario utilising the method of the invention, showing two lower accuracy radars employed at a wind farm;

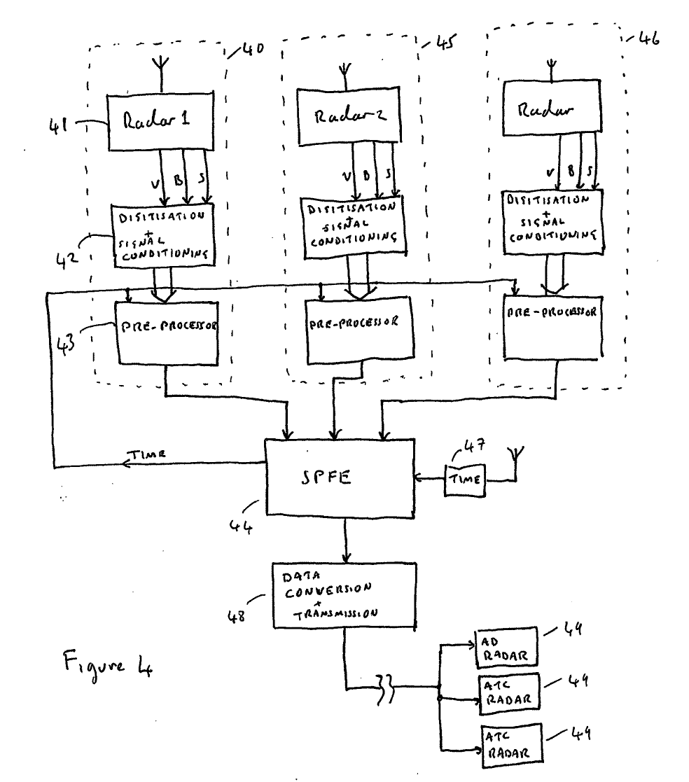

FIG. 4 shows a block diagram of the steps involved in generating and processing data from the at least two lower accuracy radars;

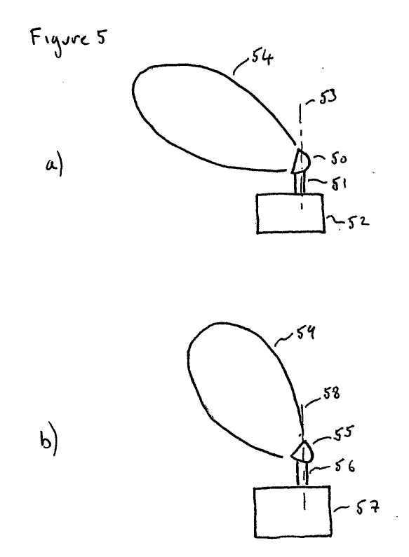

FIG. 5 diagrammatically illustrates different antenna arrangements that may be adopted on the lower accuracy radars, to put a radar into either the first or the second group.

Referring to FIG. 1, a wind farm 1 is located on a plain 2. The wind farm 1 comprises several wind turbines e.g. 3 each located on a tall tower. Some distance away from the wind farm 1 is an ATC radar 4 positioned to track aircraft within a large area 5, this area including a region 6 above the wind farm 1. The antenna of the ATC radar is designed to have a narrow beam in azimuth, and a wide beam in elevation. Thus with a single rotation it is able to scan the entire area 5 for aircraft. The wide elevation beam also illuminates the wind farm 1, which will reflect energy back to the radar 4. The reflected energy will be modulated by the moving blades of the turbines 3, and so will have Doppler frequency components added. This makes filtering of the signals in the ATC radar 4 much harder, as they will not be blocked by normal MTI or MTD/Doppler filter(s) used to remove static clutter signals.

An aircraft 7 present in the sky at the same slant range as the wind farm 1 will reflect radar signal returns back to the ATC radar 4 that will arrive at the same time, or times very close to those of the returns from the wind farm. Wind farm returns will thus be mixed in with wanted returns from the aircraft 6, and will tend to make accurate plotting of the position and speed of the aircraft more difficult. It is also possible for the reflections from the wind farm to be significantly larger than those form the target aircraft, which causes additional detection issues.

A known solution to this problem is to site a second ATC radar 8 at a location whereby it is able to see the region above the wind farm 1 but is masked from it by a geographical feature such as a hill 9. As previously explained, this is disadvantageous from a cost and planning point of view, and may not suit all locations due to the requirement of the suitably positioned hill 7 or other geographical feature to provide adequate blockage between the radar and the wind farm.

The wind farm may be located out to sea, where it may generate interference not only to ATC and AD radars but also to VTS radars monitoring ship movements. Similar issues in terms of interference apply in this situation, but the option of siting a patch-in VTS radar behind a hill will not be available.

FIG. 2 shows a part of an ATC radar display, as it may be seen by an ATCO. The lower set of traces 10 represents a plot history of a target such as an aircraft. As the target has moved towards the right it flew over a wind farm in region 11 containing several wind turbines, and then past the region 11 back over normal ground. The latest plot 12 is shown. It can be seen that the traces in region 11 are heavily distorted compared with those either side of it. Traces from the wind turbines are visible, which are difficult to distinguish from the aircraft traces, but which have also caused a loss of detection of the aircraft in that region. The loss of detection, coupled with the difficulty in distinguishing aircraft traces from the wind farm traces can lead to problems interpreting the behaviour of the aircraft at that point, which of course leads to clear issues with the provision of air traffic services.

FIG. 3 illustrates the principle of the present invention. A first lower accuracy radar 20 is positioned in the vicinity of a wind farm 21. It has a rotatable antenna 22 adapted to rotate on a vertical axis. The antenna has a broad beam in the vertical plane and a narrow beam in the plane perpendicular to the vertical axis. A static beam pattern, indicating relative signal strength with vertical angle, for antenna 22 is shown 23. As the antenna 22 rotates it scans the region above the wind farm 21 and the radar 20 generates information relating to the position of detected targets. The information generated by a single radar 20 comprises slant range and bearing information. Height information is not present due to the breadth of the beam in the vertical plane, and the resultant positional uncertainty this gives.

A second and a third lower accuracy radar 24 and 25, mounted again in the vicinity of the wind farm 21 but located spatially separately from the first radar 20, are similarly arranged to sweep the region above the wind farm 21. Static beam patterns 26, 27 indicating relative signal strength with vertical angle for the respective radars 24, 25 are again shown. As the radars 20, 24, 25 are all able to detect targets in the region above the wind farm this region is known as the common area. Each radar 20, 24, 25 is able to determine a slant range and bearing to a target, in similar fashion to radar 20. Each radar 20, 24, 25 is co-located with a pre-processor unit for pre-processing the radar's data as described below in relation to FIG. 4.

The pre-processor of each of the radars 20, 24, 25 provide data outputs to a computer system 28 which combines the data from the respective radars to generate more accurate target location and tracking information.

A single target 29 comprising an aircraft in the common area is located by each radar 20, 24, 25 as being at a given slant range and bearing from each one. As explained above, navigational radars generally only give a slant range and bearing. However, by combining the outputs of the radars, a unique target location can be deduced by examination of where the acquired range values meet.

Of course, although FIG. 3 shows three lower accuracy radars, it will be apparent to a person having ordinary skill in the art that a minimum of two are required to generate a unique location, but by increasing the number of lower accuracy radars, each located at different positions, the overall accuracy of the target location will be increased.

It will be seen from FIG. 3 that the beam pattern 23 for radar 20 has a sensitivity at a much higher angle than those of radars 24 and 25. This enables it to detect targets more directly overhead. A preferred embodiment of the invention is therefore to incorporate a radar having a more elevated beam pattern in a central region of the wind farm 21. Such a radar is in the first group as defined above, whilst radars 24 and 25 are in the second group. Radars 24 and 25 of the second group are advantageously located in areas around the periphery of the wind farm 21, or even beyond its extent, but still close enough for the common area to be within their instrumented range.

Some or all of the radars may be used with a clutter fence that reduces radiation reflections from directions not of interest from being received, and so reduces the clutter therefrom. This is particularly suitable for radars in the first group, where the region more directly above the radars is of most interest. The clutter fence may comprise radiation absorbent material (RAM) or reflectors positioned so as to block the radar's view in undesired directions. The RAM or reflector may be angled so as to further reduce the radiation received from the undesired direction, for example by reflecting the sky towards the radar.

Preferred locations of the radars e.g. 20, 24, 25, relative to the wind farm itself will depend upon the terrain, the size and shape of the wind farm, the turbine density, and the available radar siting locations. The radars may be located on towers, with one or more on the same tower if required. Radars on the same tower may be a mix from the first and second group, or may comprise radars from the same group. They may advantageously have differing characteristics, such as being operable at different RF frequencies or frequency bands to each other, or working at different azimuth scan rates. The radars may be mounted on to or on top of individual wind turbine nacelles in a wind farm if this is thought to be advantageous. Should this be done then radars from the first group are preferably mounted more centrally in the wind farm compared to those from the second group.

Any radars sited around the periphery of the wind farm may have different antenna characteristics to those mounted inside the wind farm. In particular, radars having antennas in the first group as described above will tend to be positioned more centrally in the wind farm, or within an inner peripheral region, whilst those having antennas in the second group will tend to be positioned at or around the periphery of the wind farm, although other arrangements, such as radars from the second group being more centrally located will also be effective.

FIG. 4 shows a simplified block diagram of the operation of an embodiment of the present invention. A radar unit 40 comprises a lower accuracy radar 41, which may be a marine navigational radar as described above. The unit 40 also comprises a digitisation and signal conditioning unit 42 in communication with the radar 41, and a pre-processor unit 43 in communication with the conditioning unit 42. Radar 41 generates, in operation, a raw video signal along with bearing and synchronisation information. These signals are received by the unit 42 where they are buffered, digitised (where they are not already in digital form), and provided to pre-processor 43. The video, bearing and synchronisation signals contain information relating to target bearing and slant range. This information is extracted in pre-processor 43, which generates, from a sequence of such data, target plot and track information. As a single radar 41 is ambiguous in terms of target altitude, the plot and track produced will, at this stage, comprise bearing and slant range information.

The pre-processor 43 also processes the data to reduce the effects of localised clutter and the effects of rain by using known techniques. These include STC, wherein the gain of the receiver is reduced if large clutter signals are received from nearby objects, and FTC processing in which high pass filters are used to reduce clutter from, e.g. rain. The pre-processor also includes both long term and short term clutter map storage. Using a short term clutter map allows the rapid identification, and process out, areas of high clutter. Having a long term clutter map allows the computer to build up a sustained clutter map, removing any short term variability effects and mitigating against the risk of having a complete system reset causing a performance reduction.

Constant false alarm rate (CFAR) processing may also be employed to reduce target false alarms. Additional signal processing such as within-beam integration, techniques may be applied as described above to improve detection.

The radar 41 may comprise a radar from the first group or from the second group as discussed above.

The output of pre-processor 43 is a set of plots and tracks corresponding to detected target information over a succession of detections, and processed to reduce clutter effects. Each plot has associated time information provided by a time input from a time reference 47 via Sensor Plot Fusion Engine (SPFE) processor 44.

Other radar units 45 and 46 are similar in function to radar unit 40 described above, and so will not be described in detail further. They may differ in terms of whether their associated lower accuracy radars are from the first or second group. They may also differ in terms of their frequency of operation, either in terms of being slightly different so as to reduce interference between radars, or being operated in different frequency bands. The latter provides advantages in terms of propagation effects, multipath, susceptibility to rain clutter etc as detailed above. Although three radar units 40 45, 46 are shown, there may of course be more if in any particular embodiment of the invention. A typical embodiment will have a single radar from the first group (approximately centrally located in the wind farm or other region of interest), with remaining radars being from the second group.

Plot information from each radar unit 40, 45, 46, comprising aircraft location data, is provided to SPFE 44. Here the time-coded plots from different radar units are sorted into time order then fused using a Kalman filter to produce associated plot or track information of improved accuracy compared to track information that would be normally obtained from individual radar units. This is known as plot fusion. An alternative approach which may also be employed in an embodiment of the invention is track fusion, where track information (i.e. a sequence of plot information) from individual radars is combined to produce a more accurate track. These fusion techniques, such as the Kalman filter and EKF are known. See for example the references cited earlier. The technique used may depend upon the intended recipient for the output data and the overall system architecture. Current ATC radars are likely to prefer to receive plot data, and therefore fused plot information would be supplied, whereas AD radars are generally able to accept track information, and hence fused track data would be supplied to them. Current VTS radars work on pure video or on plot information, therefore fused plot information would generally be supplied.

The SPFE has an input from a time reference 47, such as from a Global Positioning System receiver. This clock reference 47 is distributed to the radar units 40, 45, 46 as mentioned earlier. An alternative time system may be used. E.g. a precise time source such as a caesium clock reference may be used provided that it's time is distributed to the other sensors in the network using a network distribution protocol such as Network Time Protocol (NTP).

Other information may be provided to the SPFE, for example ADS-B aircraft transmissions, or from electro optic sensors, to improve the accuracy of the output track or plot information, or to add identification tags to tracks or plots.

The output track and/or plot information from the SPFE 44 is then converted to a format recognised by subscribing ATC or AD radar(s) 49 in data conversion/transmission unit 48, and the formatted data is then sent to the ATC or AD radar(s) 49 for integration with their own data.

The ATC or AD radars 49 are configured to take output track or plot information as described above and to mix it with data received from its own high accuracy radar system. The data from unit 48 corresponding to aircraft data above the wind farm is used to replace the corresponding data from radar 49. The effect of this is to remove the distorted data (as shown at 11 in FIG. 2) with information of improved accuracy. This data is used by the ATC or AD radar 49 system in conventional manner.

Although the above example has been described with respect to air targets and ATC and AD radars, similar techniques may also be used for the detection of ships, with the fused data comprising improved accuracy information being passed to operators of VTS radars. Of course, the wind farm would in that instance be an offshore wind farm. In such a case, the radars may conveniently be mounted on the nacelles of the turbines, or on floating buoys positioned within or around the wind farm itself.

FIG. 5 shows two different radar antenna arrangements, along with their respective beam patterns. FIG. 5a shows an antenna arrangement typical of that found on lower accuracy navigational radars. Antenna 50 is rotatably attached, using mounting means 51, to a radar transceiver 52. The antenna 50 has a vertical axis 53 of rotation. A typical vertical plane beam pattern is shown 54. The radar of FIG. 5a therefore comprises a radar from the second group, as its beam pattern is more suited to the detection of targets generally horizontally displaced from the radar, rather than targets directly or almost directly above it.

FIG. 5b shows a similar radar to that of FIG. 5a, but instead having an antenna 55 mounted at an increased elevation angle. The mounting means 56 is adapted to support antenna 55 at this increased elevation angle. The axis 58 of rotation is vertical as before, and the radar transceiver unit 57 is identical to that of transceiver 52 in FIG. 5a. A vertical plane beam pattern 59 associated with antenna 55 is shown, and it can be seen that the beam pattern 59 is much more directed towards the vertical. This gives the radar 57 an increased sensitivity to targets more directly overhead than that of the system of FIG. 5a. This also has the added advantage of reducing clutter returns from the surrounding terrain as less radar energy is directed towards the ground and hence even less energy is reflected back to the radar as ground clutter. The radar shown in FIG. 5b therefore comprises a radar from the first group. Additionally, the radar system may be modified to include a clutter fence or RAM screen to further improve rejection of interference and clutter from the surrounding terrain/wind farm/sea, further improving detection of targets crossing the zenith.

Antennas of radars in the second group may be adapted to provide improved elevational coverage compared to the antenna on a standard marine navigational radar, and hence also provide improved rejection of land clutter by reducing antenna gain in the direction for both transmission and receiving. This adaption of the second group radar antennas will not however be as significant as that for the radar antennas in the first group, due to the desire to track targets at longer ranges and lower elevations.

The invention has particular utility in providing radar coverage above wind farms, these being a significant source of ground based interference as described above. However the invention also has utility around other sources of interference, or in other areas where signals from the ATC or AD radars are obscured by mountains etc. References to wind farms in the embodiments provided should, where the context permits, be taken to also cover other interferers and areas obscured by mountains etc.

1. A method for mitigating the effects of an interferer or region of poor propagation on a high precision radar system comprising the steps of:
a) siting at least two lower accuracy radars, each having relatively lower accuracy compared to the high precision radar, at different positions in the vicinity of the interferer or region, with each being arranged to view a common area above or around the interferer or region;
b) recording radar data, using the at least two lower accuracy radars, from objects moving within the common area;
c) fusing together the data from the at least two lower accuracy radars to generate object location data having improved accuracy;
d) sending the improved accuracy object location data to an operator of the high precision radar for integration with existing data from the high precision radar.

2. A method as claimed in claim 1 wherein the interferer is a wind farm.

3. A method as claimed in claim 1 wherein the lower accuracy radars are marine navigational radars having antennas rotatable about a vertical axis.

4. A method as claimed in claim 1 wherein one or more of the lower accuracy radars has an antenna having a beam pattern with a lower 3 dB point of above −10° such as above 0° such as above 10° such as above 20° such as above 30° from horizontal.

5. A method as claimed in claim 1 wherein one or more of the lower accuracy radars has an antenna having a beam pattern with an upper 3 dB point of below 90° such as below 80° such as below 70° such as below 60° such as below 40° from horizontal.

6. A method as claimed in claim 4 wherein the radars are divided into a first and a second group, the first group being adapted to each have an antenna having a radiation pattern sensitive at an increased elevation angle as compared to the second group.

7. A method as claimed in claim 6 wherein the radar(s) in the first group are sited in a central area or inner periphery of the interferer, whilst those in the second group are sited in a peripheral area of the interferer.

8. A method as claimed in claim 1 wherein each lower accuracy radar generates bearing and slant range information.

9. A method as claimed in claim 1 wherein the fusing of the data is done in a computer system, adapted to perform a Kalman filtering operation to generate target position information in three dimensions.

10. A method as claimed in claim 1 wherein at least two of the radars are arranged to differ from one another in one or more characteristics chosen from their transmitted pulse width, and their frequency of operation.

11. A method as claimed in claim 1 wherein the improved accuracy object location data is sent to one or more of the operators of an air traffic control radar, an air defence radar, or a vessel traffic system radar.

12. A system for mitigating the effects of an interferer or region of poor propagation on a high precision radar, the system comprising:
a) a first group comprising at least one lower accuracy radar, and
b) a second group comprising at least one lower accuracy radar, wherein each radar in each group has a relatively lower accuracy as compared to the high precision radar, and
c) a computer system adapted to receive data from the radars in the first and second groups, the data comprising bearing and slant range information of detected targets, and to fuse the data to produce data having improved positional accuracy of the detected targets,
wherein the at least one radar in the first group is adapted to have an antenna having a radiation pattern sensitive at an increased elevation angle as compared to the at least one radar in the second group.

13. A system as claimed in claim 12 wherein the radar(s) in the first group are sited in a central area or inner periphery of the interferer or region of poor propagation, whilst those in the second group are sited in a peripheral area.

14. A system as claimed in claim 12 wherein the computer system is adapted to fuse the data from the lower accuracy radars using a filtering operation to generate target position information in three dimensions.

15. A system as claimed in claim 12 wherein at least two of the radars are arranged to differ from one another in one or more of their transmitted pulse width, or their frequency of operation.
